(19) United States
(12) Patent Application Publication
(10) Pub. No.: US 2024/0001781 A1
(43) Pub. Date: Jan. 4, 2024

(54) CHARGING DEVICE FOR A MOTOR VEHICLE

(71) Applicant: Kiekert AG, Heiligenhaus (DE)

(72) Inventors: Tim SONNESCHEIN, Wuppertal (DE); Benjamin DJEDOVIC, Oberhausen (DE)

(73) Assignee: Kiekert AG, Heiligenhaus (DE)

(21) Appl. No.: 18/252,389

(22) PCT Filed: Dec. 2, 2021
(86) PCT No.: PCT/DE2021/100959

§ 371 Date: May 10, 2023

(30) Foreign Application Priority Data
Dec. 2, 2020 (DE) 10 2020 132 024.8

(51) Int. Cl. B60L 53/16

(52) U.S. Cl. CPC B60L 53/16; B60L 2270/32

(57) ABSTRACT

An electric charging device for a motor vehicle, having a locking unit and a charge plug socket. The locking unit is equipped with a motor drive for adjusting a latch element, and the latch element is designed to releasably lock a charge plug in the charge plug socket. The locking unit and the charge plug socket are releasably connected together via at least two connection aids. According to the invention, each of the two connection aids is designed as a respective combination of a latch element and a mating latch element.

The invention relates to an electric charging device for a motor vehicle, having a locking unit and a charge plug socket, wherein the locking unit has a motor drive for adjusting a latch element, wherein furthermore the latch element is provided for releasably locking a charge plug in the charge plug socket, and wherein the locking unit and the charge plug socket are releasably connected to one another via at least two connection aids.

Electric charging devices for a motor vehicle are used to supply electrical power to accumulators located in the motor vehicle. This applies in particular to accumulators of electric or hybrid motor vehicles. This relies on a charging infrastructure, which typically includes charging stations that provide the necessary electrical power. For the charging process with electrical power, the charge plug on the charging station side is generally coupled with the charge plug socket on the motor vehicle side and locked in a releasable manner. This is ensured by the latch element.

Locking with the aid of the latch element is necessary, for example, to prevent health hazards, since high voltage is generally used at this point. In addition, the locking ensures that only previously identified and authorized users lawfully draw the electrical power provided by the charging station and misuse is prevented. For this reason, an identification of the operator and an authorization check by exchange of an identification signal is usually carried out before such a charging process, as is basically described in WO 2010/149426 A1.

In the prior art according to DE 10 2011 050 783 A1, a locking device, which provides for charge plug locking in connection with a plug, is described. For this purpose, a locking device is equipped with a locking latch, which can releasably engage a charge plug. A housing of the locking device consists of two housing containers, which are attached to one another via clip connections consisting of springing tabs and wedge-shaped projections that mechanically cooperate with them.

DE 10 2015 108 831 A1 describes a locking system for a charge plug. A locking element or a latch element, which is accommodated in an adapter element, is realized. A transmission element is arranged between the adapter element and a locking drive, which transmits the movement force generated by the locking drive to the locking element. The adapter element is designed in at least 2 parts and possesses a base element and a bayonet connection. That is, in the prior art, the charge plug socket on the one hand and the locking unit on the other hand are usually firmly connected to one another mechanically by means of screws, for example.

In the generic prior art according to DE 10 2018 114 205 A1, the joining of the locking unit or of a locking actuator there with an associated charge plug socket is effected, among other things, via joining and/or connection aids addressed in claim 8. The connection aids are used to couple associated housings of the locking actuator, on the one hand, and the charge plug socket, on the other hand. Further details with regard to the connection aids remain open.

In principle, the prior art has proven itself with regard to the self-sufficient and modular design of the locking unit or the locking actuator with the latch element that can be impinged by it, on the one hand, and the charge plug socket, on the other hand. This allows both elements or units to be variably positioned in the region of a body opening accommodating the charge plug socket and simplifies assembly overall in this region. However, since in this case a screw connection or, at best, connection aids according to the generic prior art as described in DE 10 2018 114 205 A1 are predominantly used, there is the problem that screw assembly is often difficult due to the confined installation conditions. In addition, the screw assembly makes it difficult to repair or replace the locking unit or locking actuator, for example. The invention as a whole seeks to remedy this.

The invention is based on the technical problem of further developing such an electric charging device for a motor vehicle in such a way that assembly is simplified and, in particular, subsequent revisions or even replacement of individual components can be carried out without difficulty.

To solve this technical problem, a generic electric charging device for a motor vehicle within the scope of the invention is characterized in that the two connection aids for releasably coupling the locking unit to the charge plug socket are designed as a detent element and a mating detent element, respectively.

Thus, in contrast to the prior art, the invention explicitly does not resort to a permanent coupling between, on the one hand, the locking unit and, on the other hand, the charge plug socket. Rather, according to the invention, the locking unit and the charge plug socket are releasably connected to one another, specifically with recourse to the detent element and the mating detent element. That is, the releasable connection is a detent mechanism. Such a detent mechanism can easily be released again, for example to replace or revise the locking unit. Moreover, the assembly of the locking unit on the charge plug socket is simplified according to the invention, because only the detent connection between the detent element and the mating detent element has to be made and complicated screw connections are not required. In addition, within the scope of the invention, the detent connection can be made without tools, for example manually by an assembly worker. Finally, there is no need for separate stocking and feeding of screws that are not required. This is where the main advantages lie.

According to an advantageous embodiment, the detent element is arranged on the charge plug socket and the mating detent element is arranged on the locking unit, or vice versa. That is, it is also possible to proceed in such a way that the mating detent element is located on the charge plug socket, whereas the detent element is realized on the locking unit. In most cases, several detent elements/mating detent elements are provided to provide a non-tipping and tilt-free connection of the locking unit to the charge plug socket. Here, a pair of detent elements and mating detent elements have typically proven favorable.

The detent element and the mating detent element each advantageously represent an integral component of a charge plug socket housing, on the one hand, and a locking unit housing, on the other hand. The housings in question were generally plastic housings that can be manufactured in a plastic injection molding process. Since the detent element and the mating detent element are each designed as an integral component of the housing in question, both the detent element and the mating detent element can be integrated into the plastic injection molding process for the housing in question, making their manufacture and definition particularly cost-effective.

In addition, the invention proposes that the mating detent element is designed as a detent spring and that the detent element can be designed as a detent pin interacting with the detent spring. Thereby, the detent spring can be a component of a detent receptacle for the detent pin. That is, to join the locking unit with the charge plug socket, the detent pin is inserted into the detent receptacle and the detent spring as a component of the detent receptacle in conjunction with a detent hook in or on the detent pin ensures the desired detent connection. In principle, this can also be reversed. In this case, the detent spring is a component of the detent pin, whereas the detent hook is realized in the detent receptacle. Either way, both the detent spring and the detent hook, along with the detent receptacle and the detent pin, can be integrated into the respective manufacturing process for the housing in the course of plastic injection molding as overall integral components of the charge plug socket housing, on the one hand, and the latching unit housing, on the other hand.

According to a further advantageous embodiment, the detent receptacle and the detent pin are substantially rectangular in cross-section. The rectangular and corresponding design of the detent receptacle and the detent pin in cross-section allows both elements to engage without tilting on the one hand, and on the other hand ensures a rotationally fixed and aligned coupling of the latching unit with the charge plug socket. In this connection, the detent receptacle is usually designed as a cuboid cup receptacle, that is, it defines a cuboid cup. Consequently, the detent pin is a cuboid detent pin. The cuboid cup receptacle, on the one hand, and the cuboid detent pin, on the other hand, are adapted to one another in terms of size and their respective contour and cross-sectional design, in order to be able to form into the desired releasable detent connection.

The detent spring is usually a wall component of the cuboid cup receptacle mentioned earlier. In most cases, the wall component of the cuboid cup receptacle is an outward-facing wall component, that is, one that is accessible from the outside. Such a shape is advantageously recommended in the event that the detent spring is equipped with a disassembly element. With the aid of the disassembly element, the detent spring can be removed from the detent pin or the detent hook arranged on the detent pin, and the detent connection between the locking unit and the charge plug socket can be easily removed and released.

For this purpose, the disassembly element is usually a disassembly tab connected to the detent spring. This disassembly tab can easily be manually pressed by an assembly worker in order to release the detent connection between the locking unit and the charge plug socket. For this purpose, the disassembly tab generally possesses an engagement opening into which, for example, a screwdriver, a rod or other generally accessible or available tool can be inserted. That is, according to the invention, no special tool is required to remove the detent connection between the locking unit and the charge plug socket.

In a preferred embodiment, a seal is provided interposed between the locking unit and the charge plug socket. Such seal is usually a rubber seal or elastomer seal that performs two functions. First of all, the seal ensures that any gap between the locking unit and the charge plug socket is sealed from environmental influences. This is important, because the latch element is moved back and forth in this region and penetrating dirt or moisture could interfere with the functioning of the latch element. This is all the more so, because the latch element is typically made of plastic.

Secondly, the rubber seal keeps the releasable detent connection between the locking unit and the charge plug socket under tension in the installed state, in order to compensate for any play between, for example, the detent spring and the detent hook or the detent receptacle and the detent hook respectively. In addition, of course, it also provides a sealing effect.

As a result, an electric charging device for a motor vehicle is provided, which has advantages over the prior art in terms of manufacturing technology, assembly technology and noise. In fact, the releasable detent connection between the locking unit and the charge plug socket greatly simplifies assembly and also opens up the possibility of disassembly and revision. In addition, assembly and manufacturing are simplified compared to the prior art, because no additional screwing is required, which means that screws do not (any longer) have to be stocked and assembled.

In the following, the invention is explained in greater detail with reference to only one drawing illustrating an exemplary embodiment; in the figures:

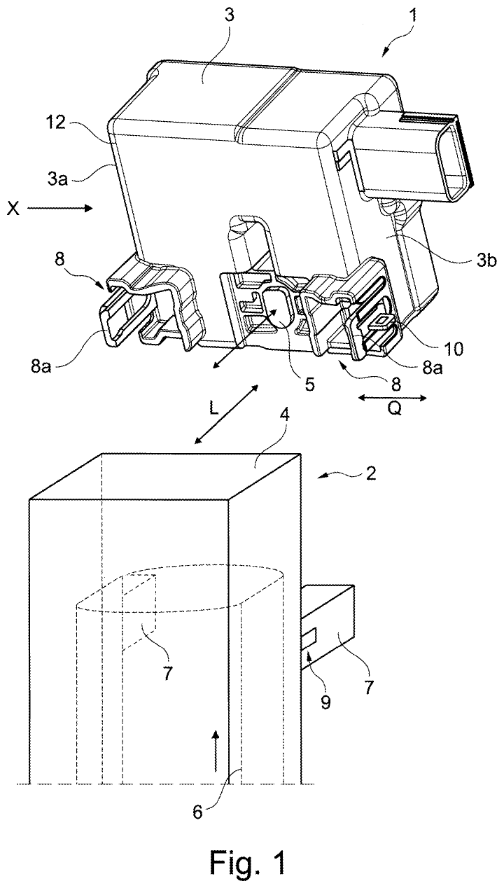

FIG. 1 shows the electric charging device according to the invention schematically, and

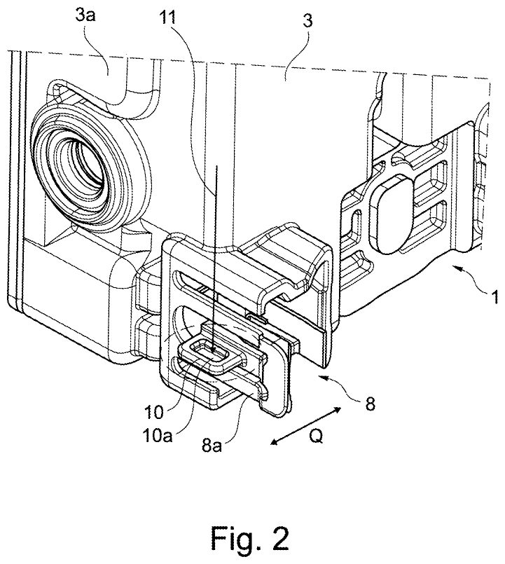

FIG. 2 shows a detail from FIG. 1 showing the direction of view X.

An electric charging device for a motor vehicle is shown in the figures. The charging device is substantially 2-part and possesses a locking unit 1 and a charge plug socket 2. The locking unit 1 and the charge plug socket 2 are each modular and self-sufficient, that is, independent of one another. The locking unit 1 and the charge plug socket 2 are joined with one another in operation and are shown in exploded view in FIG. 1 in positions separated from one another. The joining of the locking unit 1 with the charge plug socket 2 is indicated by a double arrow in FIG. 1. Both the locking unit 1 and the charge plug socket 2 each have a housing 3, 4 made of plastic, specifically a locking unit housing 3, on the one hand, and a charge plug socket housing 4, on the other hand.

The locking unit 1 is equipped internally with a motor drive, not shown in more detail, for adjusting a latch element 5. The latch element 5 is a locking pin made of plastic, with the aid of which a charge plug 6 inserted into the charge plug socket 2 can be releasably locked in the charge plug socket 2. This applies in any case in the assembled or joined state of the locking unit 1, on the one hand, and the charge plug socket 2, on the other hand. Thereby, the motor drive for the latch element 5 may be generally constructed and operate as described in detail in the generic prior art according to DE 10 2018 114 205 A1.

The locking unit 1 and the charge plug socket 2 are releasably connected to one another via at least two connection aids 7, 8. According to the invention, the two connection aids 7, 8 are in each case a detent element 7 and a mating detent element 8. In fact, according to the exemplary embodiment, a pair of each of the detent element 7 and mating detent element 8 is provided in this connection. That is, there are two detent elements 7 and two mating detent elements 8, each at the edge of their associated housings 4, 3. Thereby, the mating detent element 8 is designed as a detent receptacle 8. In this way, the locking unit 1, on the one hand, and the charge plug socket 2, on the other hand, are coupled to one another by a releasable detent connection. The releasable detent connection can be released again if necessary, as will be explained in more detail below.

Thereby, according to the exemplary embodiment, the design is such that the detent element 7 is arranged on the charge plug socket 2 and the mating detent element 8 is arranged on the locking unit 1. In principle, this can also be reversed. In addition, mixed forms are also conceivable in such a way that one of the two detent elements 7 is arranged on the charge plug socket 2, while the other detent element 7 is located on the locking unit 1. The same applies to the mating detent element 8.

The detent element 7 and the mating detent element 8 each represent an integral component of the charge plug socket housing 4 already mentioned above, on the one hand, and of the locking unit housing 3, on the other hand. In fact, according to the exemplary embodiment, the detent element 7 is formed on the charge plug socket housing 4, while the mating detent element 8 is formed on the locking unit housing 3. That is, for the realization of the detent element of the 7 and the mating detent element 8, the operation can in each case revert to a plastic injection molding operation for the manufacture of the associated housing 3, 4.

According to the exemplary embodiment, the detent element 7 is designed as a detent pin 7. In contrast, the mating detent element 8 or the detent receptacle 8 has a detent spring 8a, which interacts with the detent pin 7 or a detent hook 9 provided on the detent pin 7 and merely indicated. In principle, however, the detent spring 8a can also be equipped with a detent hook 9 as a component of the mating detent element 8, which in this case engages in an associated hook recess in the detent pin 7. Either way, the detent connection between the detent element 7 or the detent pin 7, on the one hand, and the mating detent element 8 or its detent spring 8a, on the other hand, can be removed and released by elastically pivoting the detent spring 8a as a component of the mating detent element 8, specifically in a transverse direction Q compared to the longitudinal direction L, in which the latching unit 1 and the charge plug socket 2 are joined with one another.

The possible pivoting movement of the detent spring 8a as a component of the mating detent element 8 in the transverse direction Q in question can best be understood on the basis of FIG. 2.

It can be seen that the detent element or detent pin 7, on the one hand, and the mating detent element or detent receptacle 8, on the other hand, are each substantially rectangular in cross-section. In fact, the mating detent element or detent receptacle 8 is a cuboid cup receptacle 8, whereas the detent pin 7 is designed as a cuboid detent pin 7. The respective cuboidal design of the detent receptacle 8, on the one hand, and of the detent pin 7 releasably engaging therein, on the other hand, ensures a positionally accurate and tilt-free joining of the locking unit 1 with the charge plug socket 2. In addition, the design is such that the detent spring 8a is a wall component of the detent receptacle or cuboid cup receptacle 8. In fact, the detent spring 8a is designed as a wall component of an outwardly facing wall of the cuboid cup receptacle 8. As a result, the detent spring 8a can easily be acted on from the outside and moved in the transverse direction Q, in order to be able to release the described detent connection. The substantially rectangular cuboid shape of the detent pin 7 and the mating detent element 8 in cross-section represents a preferred, but merely exemplary, shape of the detent pin 7 and the mating detent element 8. Other shapes, for example round shapes, are also possible.

In this connection, the detent spring 8a is equipped with a disassembly element 10, the shape of which can be understood in particular from FIG. 2. In the exemplary embodiment, the disassembly element 10 is a disassembly tab 10 connected to the detent spring 8a. The disassembly tab 10 has an engagement opening 10a that extends and opens perpendicular to a plane spanned by the longitudinal direction L and the transverse direction Q.

As a result, a screwdriver blade 11, for example, can engage in the engagement opening 10a of the disassembly tab 10 from above in such vertical plane and thereby directly pivot the detent spring 8a, in order to release the detent connection between the locking unit 1 and the charge plug socket 2. Instead of the screwdriver blade 11 shown in FIG. 2, other manipulation elements can of course also be used to appropriately impinge on the disassembly tab 10. A special tool is not required in this connection.

This simple disassembly is further facilitated by the fact that the mating detent element or detent receptacle 8 in the form of the cuboid cup receptacle 8 protrudes with its outwardly facing wall component carrying the disassembly tab 10 beyond a respective lateral wall 3a, 3b of the locking unit housing 3. Thereby, the disassembly tab 10 is formed onto the detent spring 8a, which in turn, together with the detent receptacle or mating detent element 8, forms an integral component of the locking unit housing 3 made of plastic.

In addition, a seal 12 is then also realized, which is interposed between the locking unit 1 and the charge plug socket 2. In the exemplary embodiment, the seal 12 is a rubber seal or elastomer seal. With their help, any assembly tolerances between the detent element 7 and the mating detent element 8 can be compensated for in each case. In addition, the seal 12 ensures that any gap between the locking unit housing 3 and the charge plug socket housing 4 is closed. At the same time, with the aid of the seal 12, the locking unit 1 is acoustically decoupled from the charge plug socket 2, which in turn is generally firmly connected to a motor vehicle body (not shown).

Finally, it can be seen from the figures that the two detent elements 7 along with the associated mating detent elements 8 substantially span a common and predominantly horizontal plane, in which the latch element 5 is also arranged. This plane is parallel to the plane spanned by the longitudinal direction L and transverse direction Q. In other words, the latch element 5 lies substantially on a connecting line between the two mating detent elements 8 and, consequently, the two detent elements 7 in the joined state between the latching unit 1 and the charge plug socket 2. As a result, any torques acting on the latch element 5 are directly absorbed and supported by the detent elements 7 or mating detent elements 8 when the charge plug 6 is releasably locked in the charge plug socket 2.

### LIST OF REFERENCE SIGNS

Locking unit 1
Charge plug socket 2
Locking unit housing 3
Housing 3, 4
Latch element 5
Charge plug 6
Detent element 7
Detent pin 7
Cuboid detent pin 7
Connection aids 7, 8
Mating detent element 8
Detent receptacle 8
Cuboid cup receptacle 8
Detent spring 8a
Detent hook 9
Disassembly tab 10
Screwdriver blade 11
Seal 12
Transverse direction Q
Longitudinal direction L

1. An electric charging device for a motor vehicle, the electric charging device comprising:
a locking unit, a latch element, and a charge plug socket,
wherein the locking unit has a motor drive for adjusting the latch element,
wherein the latch element releasably locks a charge plug in the charge plug socket, and wherein the locking unit and the charge plug socket are releasably connected to one another via at least two connection aids, and
wherein the two connection aids comprise a detent element and a mating detent element, respectively.

2. The device according to claim 1, wherein the detent element is arranged on the charge plug socket and the mating detent element is arranged on the locking unit.

3. The device according to claim 1, further comprising a charge plug socket housing and a locking unit housing, wherein the detent element and the mating detent element each comprises an integral component of the charge plug socket housing and the locking unit housing, respectively.

4. The device according to claim 1, wherein the detent element is a detent pin and the mating detent element is or has a detent spring interacting with the detent pin.

5. The device according to claim 4, wherein the detent pin is located in a detent receptacle, and the detent spring is a component of the detent receptacle.

6. The device according to claim 5, wherein the detent receptacle and the detent pin are substantially rectangular in cross-section.

7. The device according to claim 5, wherein the detent receptacle is a cuboid detent receptacle and the detent pin is a cuboid detent pin.

8. The device according to claim 7, wherein the detent spring is an outwardly facing wall component of the cuboid detent receptacle.

9. The device according to claim 4, wherein the detent spring is equipped with a disassembly element.

10. The device according to claim 9, wherein the disassembly element is a disassembly tab connected to the detent spring.

11. The device according to claim 1, further comprising a seal interposed between the locking unit and the charge plug socket.

12. The device according to claim 1, wherein the detent element is arranged on the locking unit and the mating detent element is arranged on the charge plug socket.

13. The device according to claim 1, wherein the two connection aids comprise a pair of detent elements and a pair of mating detent elements, respectively.

14. The device according to claim 3, wherein the detent element and the charge plug socket housing comprise a first integrated injection molded plastic component, and the mating detent element and the locking unit housing comprise a second integrated injection molded plastic component.

15. The device according to claim 4, wherein the detent pin has a detent hook that interacts with a hook recess of the detent spring.

16. The device according to claim 4, wherein the detent spring has a detent hook that interacts with a hook recess of the detent pin.
